(19) United States
(12) Patent Application Publication
(10) Pub. No.: US 2013/0100267 A1
(43) Pub. Date: Apr. 25, 2013

(54) APPARATUS AND METHOD FOR RECOGNIZING FINGERPRINTS

(71) Applicant: Younghyun BAEK, Seoul (KR)

(72) Inventor: Younghyun BAEK, Seoul (KR)

(73) Assignee: UNION COMMUNITY CO., LTD, Seoul (KR)

(21) Appl. No.: 13/606,229

(22) Filed: Sep. 7, 2012

(30) Foreign Application Priority Data
Oct. 21, 2011 (KR) 10-2011-0107906

(51) Int. Cl. H04N 7/18

(52) U.S. Cl. 348/77; 348/E07.085

(57) ABSTRACT

An apparatus and method for detecting fingerprints simultaneously. The apparatus includes a fingerprint sensor having a fingerprint input window on which fingers can simultaneously be placed. Fingerprint regions can be separated from a source-fingerprint image captured by the fingerprint sensor, and the fingerprint regions can be individually processed to generate fingerprint data. The fingerprint regions may be processed by a multi fingerprint region recognizing method such as a morphology calculation for image processing. Therefore, fingerprint regions can be rapidly recognized, as compared with a related-art method of using features of fingerprints, and the fingerprint sensor can have a simple structure because it is unnecessary to separate fingerprint regions using a mechanical structure as in the related art.

### CROSS-REFERENCE TO RELATED APPLICATIONS

This application claims priority from Korean Patent Application No. 10-2011-0107906, filed on Oct. 21, 2011 in the Korean Intellectual Property Office, the disclosure of which is incorporated herein by reference in its entirety.

### BACKGROUND OF THE INVENTION

1. Field of the Invention

The present invention relates to an apparatus and method for simultaneously receiving and recognizing a plurality of fingerprints, and more particularly, an apparatus and method for recognizing a plurality of fingerprints by dividing a fingerprint image including information on a plurality of fingerprints into fingerprint regions by using an image processing method for object recognition and generating fingerprint data from the fingerprint regions.

2. Description of the Related Art

Biometric methods are widely used for personal authentication because of uniqueness and invariability of biometric information. Among such biometric methods, fingerprint verification technology has been widely used for a long time because it is convenient and simple.

In fingerprint recognizing methods of the related art, only one fingerprint is input at a time. Therefore, if it is necessary to input ten fingerprints, ten input operations may be necessary, ten evaluation operations may be necessary to determine whether each fingerprint image has a sufficient quality for registration. In other words, although fingerprint recognizing methods of the related art are useful for registering one fingerprint at a time, they are not useful for rapidly registering a plurality of fingerprints.

Due to this reason, technology for simultaneously inputting a plurality of fingerprints has been developed. A wide fingerprint input widow on which a plurality of fingers can be put at the same time is necessary for inputting a plurality of fingerprints at the same time. Therefore, in an apparatus for recognizing a plurality of fingerprints, a technique of separating finger regions from a captured fingerprint image is important. The process speed or quality of such a fingerprint recognizing apparatus may be determined by the finger region separating technique.

Examples of related-art methods for acquiring a plurality of fingerprints include: a method of using black pixel arrangement characteristics through a binary image processing process and a hardware boundary setting method (U.S. Pat. No. 7,203,344); a method of illuminating a hand, obtaining an image from light scattered from the hand, and extracting skin features from the image to match the skin features with fingerprints (U.S. Pat. No. 7,899,217); a method of detecting fingerprint regions by estimating directions of friction ridges of fingers (US Patent Application Publication No.: 2010/0046812); and a method of separating fingerprints by using directivity and core information of fingerprints (US Patent Application Publication No.: 2006/0067566).

The disclosed methods commonly use characteristic features of fingerprints to extract fingerprint regions. However, if fingerprints are excessively dry or wet, it may be difficult to find characteristic features of the fingerprints such as directivities or cores of the fingerprints. Thus, in that case, fingerprint regions may not be separated, or the amount of calculation for fingerprint region separation may be significantly increased.

Furthermore, when one of two fingerprint images input together is abnormal, the abnormal image may not be processed into a fingerprint region. In this case, fingerprint processing may be complicated, or all the two fingerprint images may be rejected instead of selectively registering a normal fingerprint.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method for simultaneously receiving and processing a plurality of fingerprints by separating fingerprint regions as separate-fingerprint images by an object recognizing method and extracting fingerprint data from the separate-fingerprint images.

Embodiments of the present invention provide an apparatus for recognizing fingerprints, the apparatus including: a fingerprint sensor having a fingerprint input window to allow a plurality of fingers to be simultaneously put on the fingerprint input window; and a control unit configured to extract fingerprint data about a plurality of fingerprints from a source-fingerprint image captured by the fingerprint sensor.

The control unit may include a fingerprint region recognizer and a fingerprint data extractor. The fingerprint region recognizer may detect a plurality of fingerprint regions corresponding to the fingerprints from the source-fingerprint image, and then separate and store the fingerprint regions as a plurality of separate-fingerprint images. The fingerprint data extractor may extract feature points from the separate-fingerprint images so as to generate fingerprint data.

In an embodiment, the fingerprint region recognizer may include: a morphology calculator, a boundary line extractor, and a fingerprint region extractor.

The morphology calculator may perform a morphology calculation on the source-fingerprint image to change gray levels of the fingerprint regions to one gray level different from a gray level of a background so as to preliminarily recognize the fingerprint regions. The morphology calculation may be preformed according various known method.

For example, the morphology calculation may be carried out by performing an erosion calculation n times on the source-fingerprint image and a dilation calculation n times on the source-fingerprint image, where n is an integer greater than 1. The integer “n” may be set to a lower value as a total gray level of the source-fingerprint image is high.

The boundary line extractor may detect boundary pixels of the preliminarily-recognized fingerprint regions so as to extract boundary lines of the preliminarily-recognized fingerprint regions, respectively.

The fingerprint region extractor may generate rectangular masks including coordinates of the boundary lines and separate regions corresponding to the masks from the source-fingerprint image, the separated regions being stored as the separate-fingerprint images.

In an embodiment, the fingerprint data extractor may include a fingerprint quality checking part and a feature point extractor.

The fingerprint quality checking part may calculate a quality value of each of the separate-fingerprint images and determine whether the quality value is equal to or higher than a reference value. The feature point extractor may generate fingerprint data by extracting feature point data from a separate-fingerprint image which is separated by the fingerprint region recognizer and the quality value of which is determined as being equal to or higher than the reference value.

Other embodiments of the present invention provide a method for recognizing fingerprints, the method including: capturing a source-fingerprint image from a plurality of fingerprints using the fingerprint sensor; detecting a plurality of fingerprint regions corresponding to the fingerprints from the source-fingerprint image so as to separate and store the fingerprint regions as a plurality of separate-fingerprint images by using the fingerprint region recognizer of the control unit; and generating fingerprint data by extracting feature points from the separate-fingerprint images by using the fingerprint data extractor of the control unit.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating an apparatus for recognizing fingerprints according to an embodiment of the present invention;

FIG. 2 is a perspective view illustrating a fingerprint sensor capable of sensing two fingerprints at the same time, according to an embodiment of the present invention;

FIG. 3 is a flowchart for explaining a method for recognizing fingerprints according to an embodiment of the present invention; and

FIGS. 4A to 4D illustrate images for explaining how separate-fingerprint images are extracted from a source-fingerprint image in the fingerprint recognizing method.

### DESCRIPTION OF THE PREFERRED EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

A fingerprint recognizing apparatus 100 of the present invention is configured to capture a fingerprint image from a plurality of fingers simultaneously put on a fingerprint input window 110a and extract fingerprint data from the image. The fingerprint data contain feature point information on fingerprints, and thus it can be determined whether the fingerprints are identical by comparing the fingerprint data.

The fingerprint recognizing apparatus 100 of the present invention may be provided in one piece with or coupled to an apparatus for performing other functions (such as user registration and authentication) using fingerprint data extracted from fingers put on the fingerprint input window 110a.

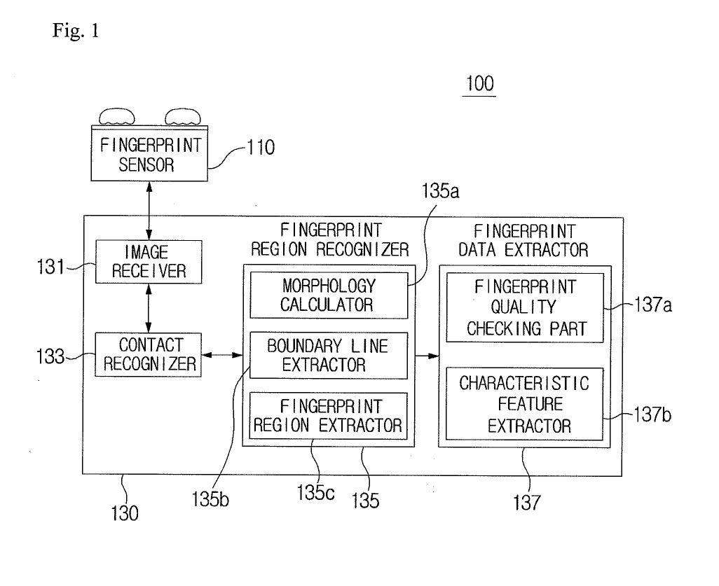

The fingerprint recognizing apparatus 100 may be configured by using an optical method using a light refractor as well as a semiconductor method or a hologram method of the related art. Hereinafter, an explanation will be given for the case where the fingerprint recognizing apparatus 100 is configured using an optical method. The optical method for the fingerprint recognizing apparatus 100 is not limited to a particular type such as a scattering type or an absorption type as long as the fingerprint recognizing apparatus 100 can recognize a plurality of user's fingerprints formed on the fingerprint input window 110a. FIG. 1 illustrates an example of the fingerprint recognizing apparatus 100.

Referring to FIG. 1, the fingerprint recognizing apparatus 100 includes: a fingerprint sensor 110 having a fingerprint input window 110a; and a control unit 130 configured to extract fingerprint data from a fingerprint image obtained using the fingerprint sensor 110.

The fingerprint sensor 110 captures an image (hereinafter referred to as a source-fingerprint image) from fingerprints of a plurality of fingers put on the fingerprint input window 110a, and provides the source-fingerprint image to the control unit 130.

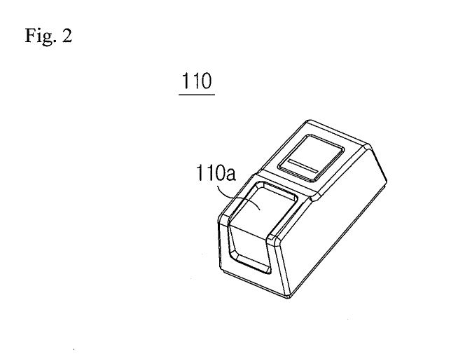

For this, the fingerprint input window 110a may have a size sufficient for placing a plurality of fingers thereon. FIG. 2 illustrates an example of the fingerprint sensor 110. Referring to FIG. 2, the fingerprint input window 110a is sized so that a fingerprint image can be obtained from two fingers of a user. A user may put his/her two fingers on the fingerprint input window 110a at the same time, and then the fingerprint sensor 110 may capture a source-fingerprint image from fingerprints of the two fingers put on the fingerprint input window 110a so as to provide the source-fingerprint image to the control unit 130.

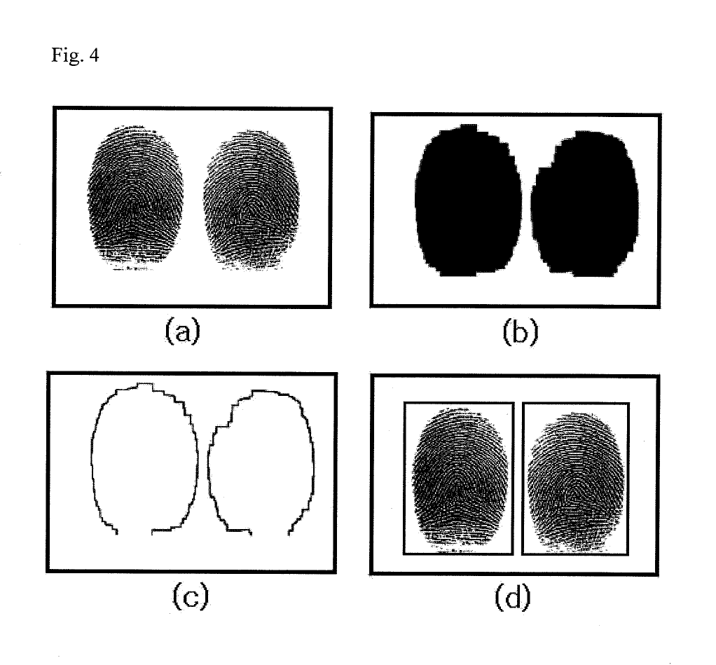

The inner structure of the fingerprint sensor 110 may be varied according to a fingerprint image acquiring method. An explanation will now be given for the case where the fingerprint sensor 110 is an optical sensor. The fingerprint sensor 110 may include: a light refractor having the fingerprint input window 110a at a side thereof; a light source configured to emit light to the light refractor for acquiring a fingerprint image; an image sensor configured to generate a fingerprint image; and an optical lens system configured to guide light from the light refractor to the image sensor for acquiring a fingerprint image. The control unit 130 reads a source-fingerprint image such as that shown in FIG. 4A to extract fingerprint data from the source-fingerprint image. FIG. 4A shows an example of a source-fingerprint image captured by the fingerprint sensor 110 and provided to the control unit 130. Two fingerprints are included in the example source-fingerprint image.

The control unit 130 divides a source-fingerprint image (including information about fingerprints of a plurality of fingers) received from the fingerprint sensor 110 into a plurality of fingerprint images corresponding to the fingerprints, and then the control unit 130 extracts feature point data of the fingerprints from the fingerprint images. Hereinafter, fingerprint images obtained by dividing a source-fingerprint image using the control unit 130 will be referred to as “separate-fingerprint images.” A source-fingerprint image contains information about a plurality of fingerprints, but a separate-fingerprint image contains information on one fingerprint.

The control unit 130 and the fingerprint sensor 110 may be provided as a module, or the control unit 130 may be provided as a separate device connected to the fingerprint sensor 110 through a particular communication interface. For example, the control unit 130 may be a computer device (or a part of the computer device) to which the fingerprint sensor 110 provided as a module is connected through a universal serial bus (USB). In this case, the fingerprint sensor 110 may include a USB interface for connection with the control unit 130.

The control unit 130 includes an image receiver 131, a contact recognizer 133, a fingerprint region recognizer 135, and a fingerprint data extractor 137.

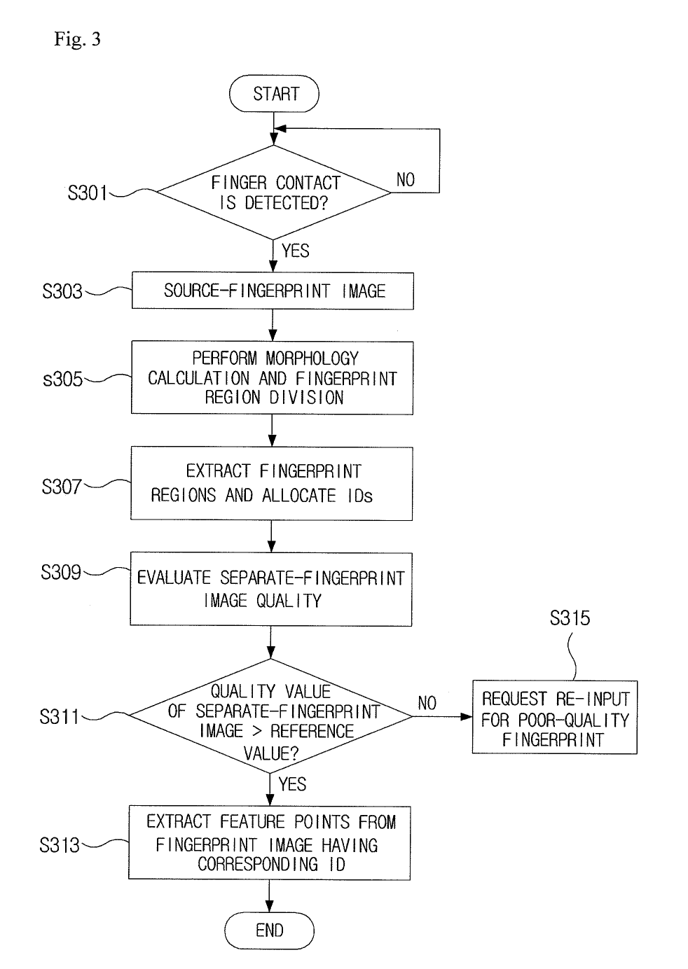

Hereinafter, with reference to FIGS. 3 and 4, a method for recognizing fingerprints will be explained based on operations of the control unit 130 according to an embodiment of the present invention. The method will be explained for an exemplary case of recognizing two fingerprints as shown in FIGS. 4A to 4D.

Finger contact detection and source-fingerprint image storing: S301 and S303

The fingerprint sensor 110 captures images from the fingerprint input window 110a and provide the images to the fingerprint region recognizer 135 of the control unit 130 at a predetermined frame rate. The images may include a source-fingerprint image as shown in FIG. 4A which is captured when a plurality of fingerprints are on the fingerprint input window 110a (two fingerprints in FIGS. 2 and 4A). The image receiver 131 receives the images provided on a frame basis by the fingerprint sensor 110.

The image receiver 131 receives all the images transmitted at a predetermined frame rate from the fingerprint sensor 110, and the contact recognizer 133 recognizes a source-fingerprint image from the images that the image receiver 131 received, the source-fingerprint image being an image captured when fingers are put on the fingerprint input window 110a. The contact recognizer 133 stores the source-fingerprint image in a buffer and provides the source-fingerprint image to the fingerprint region recognizer 135.

For recognizing the source-fingerprint image, the contact recognizer 133 detects variations of particular values (such as gray levels, brightness levels, or the number of varied pixels) of the images, and if an image is determined as a source-fingerprint image, the contact recognizer 133 stores the source-fingerprint image in the buffer and provides the source-fingerprint image to the fingerprint region recognizer 135.

Morphology calculation and fingerprint region division: S305

The fingerprint region recognizer 135 receives the source-fingerprint image from the contact recognizer 133 and separates a plurality of separate-fingerprint images from the source-fingerprint image.

The fingerprint region recognizer 135 rapidly recognizes fingerprint regions preliminarily from the source-fingerprint image by using a morphology image processing technique instead of using a related-art technique based on features of fingerprints, and then the fingerprint region recognizer 135 generates masks corresponding to the fingerprint regions based on information about boundary coordinates of the preliminarily-recognized fingerprint regions. Thereafter, the fingerprint region recognizer 135 separates a plurality of separate-fingerprint images from the source-fingerprint image using the masks.

For this, the fingerprint region recognizer 135 includes a morphology calculator 135a, a boundary line extractor 135b, and a fingerprint region extractor 135c.

The fingerprint region recognizer 135 performs a morphology calculation on the source-fingerprint image to preliminarily recognize regions having a gray level different from the gray level of a background (a region other than the fingerprint regions) as the fingerprint regions.

In general, the term “morphology” refers to a branch of biology that deals with the shape or structure of animals and plants. In the field of image processing, morphology refers to a mathematical morphology for expressing or describing the shapes of regions such as boundaries, frames, and convex hulls.

Basically, morphology calculation means a process of varying the shape of an image while maintaining the basic features of the image. Examples of morphology calculations include an erosion calculation, a dilation calculation, an opening calculation in which dilation is carried out after erosion, and a closing calculation in which erosion is carried out after dilation. Morphology calculation is a typical image processing technique for thinning and preprocessing (noise removal and feature extraction) as well as image segmentation in the present invention.

That is, owing to the characteristics of morphology calculation, various structures may be expressed, and various structural elements may be designed as masks. In addition, morphology calculation is useful to combine desired regions of an image into one region and extract the one region by using geometric information on an object that is known or acquired beforehand. As described above, through a morphology calculation on the source-fingerprint image instead of a calculation depending on unique features of fingerprints, fingerprint regions can be converted into blob images as shown in FIG. 4B, and boundary line information can be obtained as shown in FIG. 4C so as to cut out fingerprint regions.

The morphology calculator 135a may perform any morphology calculation in which a region having a gray level different from the gray level of a background (the other region) is determined as a fingerprint region.

For example, the morphology calculator 135a may repeat an erosion calculation n times (n is an integer greater than 1) on a source-fingerprint image as shown in FIG. 4A, and then a dilation calculation n times on the source-fingerprint image so as to make fingerprint regions have the same gray level like blobs shown in FIG. 4B.

At this time, the morphology calculator 135a may determine whether the source-fingerprint image is captured from dry fingers (low gray levels) or wet fingers (high gray levels) based on the total gray level (or brightness level) of the source-fingerprint image, and the morphology calculator 135a may vary the number “n” of iteration according to the determination result.

For example, the morphology calculator 135a may classify gray levels into three levels. Then, if the gray level of a source-fingerprint image is lower than a first reference because the source-fingerprint image is generally bright, n may be set to N1 (n=N1), and if the gray level of the source-fingerprint image is higher than a second reference because the source-fingerprint image is generally dark, n may be set to N3 (n=N3) (N1>N3). If the gray level of the source-fingerprint image is between the first and second references, n may be set to N2 (n=N2) (N1>N2>N3).

The boundary line extractor 135b extracts boundary pixels of the fingerprint regions from the image processed by the morphology calculator 135a, so as to generate an image as shown in FIG. 4C. The image shown in FIG. 4C has a plurality of boundary lines (two in FIG. 4C) that are generated after the source-fingerprint image shown in FIG. 4A is processed.

The boundary line extractor 135b may extract boundary lines by using an edge tracing algorithm or a boundary flowing algorithm of the related art.

Extracting fingerprint regions and allocating IDs to separate-fingerprint images: S307

The fingerprint region extractor 135c recognizes fingerprint regions by detecting x and y coordinates of each fingerprint region based on boundary lines extracted by the boundary line extractor 135b, and generates separate-fingerprint images.

Specifically, the fingerprint region extractor 135c generates a plurality of rectangular masks including the boundary lines having different coordinates as shown in FIG. 4C and applies the masks to the original source-fingerprint image as shown in FIG. 4D so as to separate images corresponding to the coordinates of the masks as a plurality of separate-fingerprint images. The fingerprint region extractor 135c allocates identifications (IDs) to the separate-fingerprint images and stores the separate-fingerprint images which correspond to fingerprints, respectively.

Quality evaluation for separate-fingerprint images, and feature point extraction: S309 to S313

After the source-fingerprint image is divided into the plurality of separate-fingerprint images by the fingerprint region recognizer 135, the fingerprint data extractor 137 extract feature point data (fingerprint data) of each fingerprint from the separate-fingerprint images. For this, the fingerprint data extractor 137 includes a fingerprint quality checking part 137a and a feature point extractor 137b.

The fingerprint quality checking part 137a determines whether the quality of a separate-fingerprint image obtained using the fingerprint region recognizer 135 is acceptable. The fingerprint quality checking part 137a may evaluate the quality of a fingerprint. For example, the fingerprint quality checking part 137a may use a check module containing international standards on fingerprint quality regulated by National Institute of Standards and Technology (NIST) to determine whether the quality of a fingerprint image is acceptable. If a quality value of the separate-fingerprint image is equal to or higher than a reference value (60 or more in NIST), the fingerprint quality checking part 137a may determine that fingerprint information of the separate-fingerprint image is acceptable. The method of evaluating the quality of fingerprints will be described again (S309, S311).

The feature point extractor 137b extracts feature point data as fingerprint data from the separate-fingerprint image which has been determined in operation S322 as having a fingerprint quality value equal to or greater than a reference value (S313).

In operation S311, if it is determined that the quality value of the separate-fingerprint image is lower than the reference value, the fingerprint quality checking part 137a determines the separate-fingerprint image as an error.

In this case, the separate-fingerprint image is discarded without extracting feature point data from the separate-fingerprint image. In addition, a massage may be displayed to request a user to input a fingerprint again which correspond to the separate-fingerprint image determined as an error.

In this way, although at least one of a plurality of input fingerprints is determined as an error, the entire source-fingerprint image may not be treated as an error.

The fingerprint data extractor 137 may extract feature point data by any extraction method known in the related art. Since the present invention is not characterized by the extraction method, a description thereof will be omitted.

According to the fingerprint recognizing method of the present invention, fingerprint data can be extracted from a plurality of fingerprints. The fingerprint recognizing method does not use unique features of fingerprints and is not limited by hardware, but a plurality of fingerprints can be recognized more rapidly and precisely through image processing technology and parallel processing technology by the fingerprint recognizing method.

Fingerprint Quality Evaluation

The quality (state) of a fingerprint such as curvature of ridges and cuts in the ridges can be expressed by a numerical value. Generally, the quality of a fingerprint region is expressed by the state or number of feature points.

The fingerprint quality checking part 137a may determine the quality of a fingerprint region through various methods. For example, the fingerprint quality checking part 137a may check the state of feature points that are considered as most important indexes for recognizing a fingerprint. If a fingerprint has curved ridges or a cut in the ridges, the number of feature points extracted from an image of the fingerprint may be different from the number of feature points of a normal fingerprint. For example, the number of feature points of a normal fingerprint is within a reference feature point number range. However, ridges are curved or cut, a necessary number of feature points may not be extracted or an excessive number of feature points may be extracted. If the number of feature points is out of the reference feature point number range, it may generally be determined as a case where many abnormal feature points are included. However, since the number of feature points can be varied according to user's input behaviors, a fingerprint input process is considered important.

Therefore, in addition to evaluation using the check module regulated by NIST, the quality of a fingerprint may be evaluated using different references according to purposes. For example, the quality of a fingerprint may be evaluated by determining whether the number of extracted feature points is within a certain reference feature point number range (for example, a range for user authentication).

Specifically, the fingerprint quality checking part 137a may extract all the feature points (both the normal and abnormal feature points) of a separate-fingerprint image, and then the fingerprint quality checking part 137a may calculate the ratio of a difference between the number of normal feature points and the number of abnormal feature points to the number of all feature points. Thereafter, whether the ratio is within a reference range may be expressed by a numerical value to determine the quality of a fingerprint. The quality of a fingerprint may be digitalized by calculating a quality value using Equation 1.

$$Quality Value = \frac{( A \times {f}_{p} ) - ( B \times {f}_{n} )}{{f}_{T}} \qquad [ Equation 1 ]$$

where f_{T} denotes the number of all feature points, fₚ denotes the number of normal feature points, fₙ denotes the number of abnormal feature points, and A and B denote weight values.

The weight values A and B may be varied according to the number f_{T} of all feature points. If the number f_{T} of all feature points is within a reference feature point number range that is obtained from an experiment performed on normal fingerprints, the weight values A and B may be set to be equal.

If the number f_{T} of all feature points is greater than the reference feature point number range, the fingerprint quality checking part 137a may set the weight value B to be smaller than the weight value A. This setting is because the possibility that friction ridges of a finger have poor quality is higher than the possibility of errors during a finger touch and a fingerprint acquiring process.

If the number f_{T} of all feature points is smaller than the reference feature point number range, the fingerprint quality checking part 137a may set the weight value B to be greater than the weight value A.

If a quality value of a fingerprint image calculated using Equation 1 is less than a reference value, the fingerprint quality checking part 137a may display a massage on a display to inform a user of that situation and to request a re-input of a fingerprint.

As described above, the fingerprint recognizing apparatus of the present invention can extract and process a plurality of fingerprint regions from a fingerprint image through a morphology calculation for object recognition. Therefore, according to the present invention, it is not necessary to extract fingerprints based on unique features of fingerprints, and thus a fingerprint recognizing process can be performed more rapidly. In addition, it is unnecessary to separate finger boundaries using an additional structure, and thus a small and simple fingerprint sensor can be used.

Furthermore, according to the present invention, a fingerprint image including a plurality of fingerprints that are simultaneously input can be divided into separate-fingerprint images, and the separate-fingerprint images can be individually processed. Therefore, the separate-fingerprint images can be selectively processed according to the qualities of the separate-fingerprint images, and thus a fingerprint recognizing process can be performed in a shorter time with high reliability.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. An apparatus for recognizing fingerprints, the apparatus comprising:
a fingerprint sensor comprising a fingerprint input window on which a plurality of fingers may be simultaneously placed; and
a control unit extracting fingerprint data about a plurality of fingerprints from a source-fingerprint image captured by the fingerprint sensor, wherein the control unit comprises:
a fingerprint region recognizer detecting a plurality of fingerprint regions corresponding to the fingerprints from the source-fingerprint image, and separating and storing the fingerprint regions as a plurality of separate-fingerprint images, and
a fingerprint data extractor extracting feature points from the separate-fingerprint images and generating the fingerprint data.

2. The apparatus of claim 1, wherein the fingerprint region recognizer comprises:
a morphology calculator performing a morphology calculation on the source-fingerprint image, changing gray levels of the fingerprint regions to one gray level, different from a gray level of a background and preliminarily recognizing the fingerprint regions;
a boundary line extractor detecting boundary pixels of the fingerprint regions preliminarily-recognized and extracting respective boundary lines of the fingerprint images preliminarily-recognized; and
a fingerprint region extractor generating rectangular masks including coordinates of the boundary lines separating regions corresponding to the masks from the source-fingerprint image, the regions separated being stored as the separate-fingerprint images.

3. The apparatus of claim 2, wherein the morphology calculator performs an erosion calculation n times on the source-fingerprint image and a dilation calculation n times on the source-fingerprint image, where n is an integer greater than 1.

4. The apparatus of claim 3, wherein the morphology calculator sets the integer “n” to a lower value as a total gray level of the source-fingerprint image increases.

5. The apparatus of claim 1, wherein the fingerprint data extractor comprises:
a fingerprint quality checking part calculating a quality value of each of the separate-fingerprint images and determining whether the quality value is equal to or higher than a reference value; and
a feature point extractor generating the fingerprint data by extracting feature point data from a separate-fingerprint image, which is separated by the fingerprint region recognizer, when the quality value is equal to or higher than the reference value.

6. A method for recognizing fingerprints by using a fingerprint recognizing apparatus including: a fingerprint sensor having a fingerprint input window on which a plurality of fingers may be simultaneously placed; and a control unit extracting fingerprint data about a plurality of fingerprints from a source-fingerprint image captured by the fingerprint sensor, the method comprising:
capturing a source-fingerprint image from a plurality of fingerprints, using the fingerprint sensor;
detecting a plurality of fingerprint regions corresponding to the fingerprints from the source-fingerprint image and separating and storing the fingerprint regions as a plurality of separate-fingerprint images, using a fingerprint region recognizer of the control unit; and
generating the fingerprint data by extracting feature points from the separate-fingerprint images, using a fingerprint data extractor of the control unit.

7. The method of claim 6, wherein the detecting of the fingerprint regions comprises:
preliminarily recognizing the fingerprint regions by performing a morphology calculation on the source-fingerprint image and changing gray levels of the fingerprint regions to one gray level, different from a gray level of a background;
detecting boundary pixels of the preliminarily-recognized fingerprint regions and extracting boundary lines of the preliminarily-recognized fingerprint regions, respectively; and
generating rectangular masks, including coordinates of the boundary lines separating regions corresponding to the masks, from the source-fingerprint image, and storing the separated regions as separate-fingerprint images.

8. The method of claim 7, wherein the morphology calculation in the preliminarily recognizing of the fingerprint regions includes performing an erosion calculation n times on the source-fingerprint image, and, subsequently, a dilation calculation n times on the source-fingerprint image, where n is an integer greater than 1.

9. The method of claim 8, wherein, in the recognizing of the fingerprint regions, the integer “n” is set to a lower value as a total gray level of the source-fingerprint image increases.

10. The method of claim 6, wherein the generating of the fingerprint data comprises:
calculating a quality value of each of the separate-fingerprint images and determining whether the quality value is equal to or higher than a reference value; and
generating the fingerprint data by extracting feature point data from a separate-fingerprint image separated by the fingerprint region recognizer if the quality value is determined as being equal to or higher than the reference value.
